(19) United States
(12) Patent Application Publication
(10) Pub. No.: US 2020/0067993 A1
(43) Pub. Date: Feb. 27, 2020

(54) Methods and system for placing a video call over a communication network

(71) Applicants: Farokh Hassanzadeh Eskafi, San Jose, CA (US); Aleks Ohannes Gollu, El Cerrito, CA (US)

(72) Inventors: Farokh Hassanzadeh Eskafi, San Jose, CA (US); Aleks Ohannes Gollu, El Cerrito, CA (US)

(21) Appl. No.: 16/543,558

(22) Filed: Aug. 18, 2019

Related U.S. Application Data
(60) Provisional application No. 62/720,123, filed on Aug. 21, 2018.

(51) Int. Cl. H04L 29/06

(52) U.S. Cl. CPC H04L 65/1069; H04L 65/403; H04L 65/1073; H04L 65/1006

(57) ABSTRACT

A system and method are disclosed for a single action video call that allows a person to video call another person. The single action can be a mouse click over a URL or a button on a website, or a QR scan of a printed promotional advertising. Furthermore, this single action creates a video call between the two people regardless of platform or computing element that they are using. The single action actor can be on smartphone, laptop, or desktop using a browser or a video application. The intended receiver of the video call can also receive the call on a browser or a video app.

### CROSS REFERENCE TO RELATED APPLICATION

This application claims the benefit of Provisional Patent No. 62/720,123 filed on Aug. 21, 2018

### BACKGROUND OF THE INVENTION

A vast number of desktop and laptop computers and smartphones are interconnected through communication links provided by Internet. Voice over Internet Protocol (VoIP) has been used to provide voice services to connect users of the Internet for real time voice applications. In the recent years, we have also seen a prevalence of video calls among users using apps running on smartphones. This trend started with text chat services and evolved to voice chat services and ultimately to real time video calls.

For example, a person may use an app on a smartphone to contact a family member, a friend, or acquaintance. Or multiple professional colleagues may set a date and time to enter a virtual room for a video call.

All these services rely on the fact that the two side of the communication know each other and if not, will get permissions first and then connect.

In consumer to consumer manifestations, both sides know each other well, or have taken an action to friend each other, and then are in ongoing dialogue.

In business to business to business manifestation, both sides are tech savvy, typically have installed some infrastructure software to be able to have a virtual meeting.

However, this overhead of getting permissions, installing a specific piece of software, or exchanging initial connection information with each other over a separate channel is cumbersome for businesses to attract customers to communicate with them. In essence there is no manifestation of online video calls that can be placed by a customer to a business with a single action, without any downloading, friending, registration . . . .

### SUMMARY OF THE INVENTION

An embodiment of the present invention provides a method and system for placing a video call from a browser or an app on a smart phone or computer. This embodiment doesn't require prior permission to contact the receiver of the video call. Furthermore, the transmitter and the receiver can be on any device or any browser and still receive the video call. This is ideal for communications from consumers to business, where the calls are primarily ad hoc. The invention is also applicable to business to business interactions especially the relationship between the two businesses of that of customer and vendor.

### BRIEF DESCRIPTION OF THE DRAWINGS

FIG. 1 illustrates single-action video call in one embodiment of the present invention

FIG. 2 is a block diagram illustrating an embodiment of the present invention

FIG. 3 is a flow diagram of a routing that enables single-action video call for a customer

FIG. 4 is a diagram of different modules inside a smartphone or computer with a. browser for single action call

FIG. 5 is a diagram of different modules inside a smartphone with an application for single action call

FIG. 6 is a flow diagram for single action scanning using a QR code

FIG. 7 illustrates single action video call using a form to identify the user of the transmitter to the receiver

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

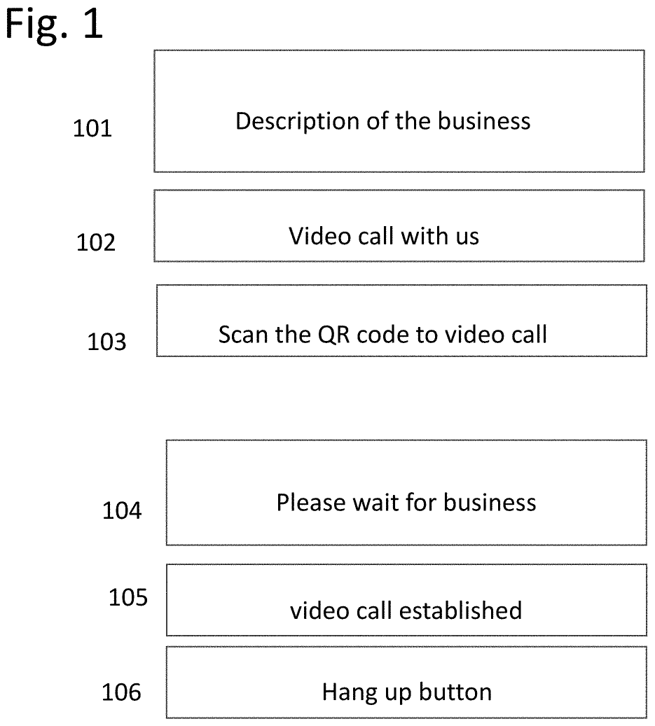

The present invention provides a method and system for single-action video call system. FIG. 1 illustrates single-action video call in one embodiment of the present invention. In this example the consumer will see a description of the business or promotions in a website, social media, email, or print media section 101, and a single-action button or link for video call section 102, or a single-action QR code section 103. The consumer only needs to click or touch the button or URL or scan the QR code, after which, a page opens that instructs the consumer to wait for connection, section 104, and when the video is connected, then the consumer will see the business through video. If the consumer has video camera, the business can also see the consumer if the consumer chooses to enable the camera. The consumer and the business page both have a hang up button or URL link that allows them to terminate the call section 106. One skilled in the art would appreciate that these various sections can be omitted or rearranged or adapted in various ways.

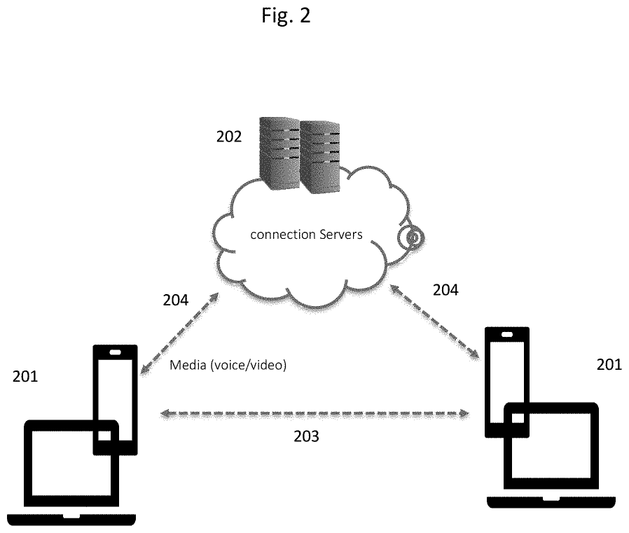

FIG. 2 is one embodiment of a network that allows single-action video call.

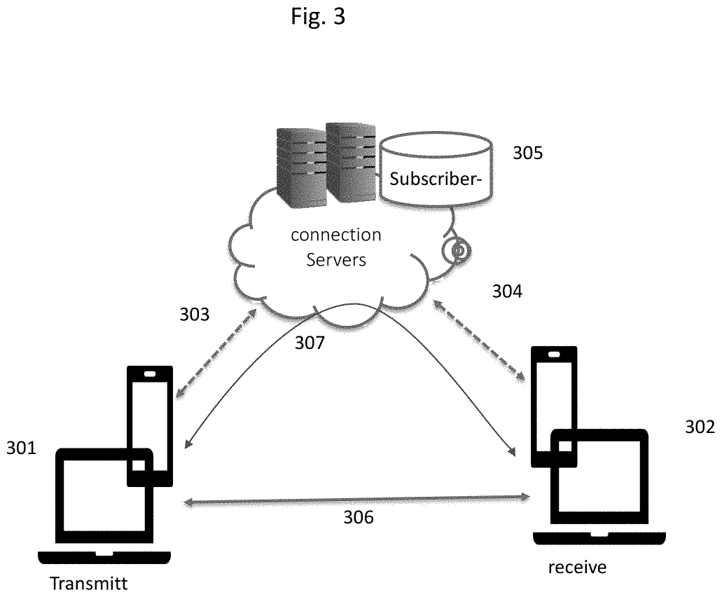

The network consists of end points (201), and servers (202). Servers might be hosted in the cloud or in a specific business's server room. The video connection between end points can be peer-to-peer (203) or using the server (204). FIG. 3 shows a network that incorporates control channels to manage call establishments, reconnections, and terminations. In one embodiment, the transmitter's (301) intention to video call the receiver (302) is relayed (303) to the connection server that has a subscriber database (305). The subscriber database holds the network location and IP address of the receiver and notifies the receiver (304) of a request to connect via video. If receiver accepts the video call, then connection server establishes the video connection in either peer-to-peer (306) or via the connection server (307).

End points can be a browser in a computer system or a mobile smartphone or an app in a mobile phone. Both browser and the app should be capable of establishing a video connection.

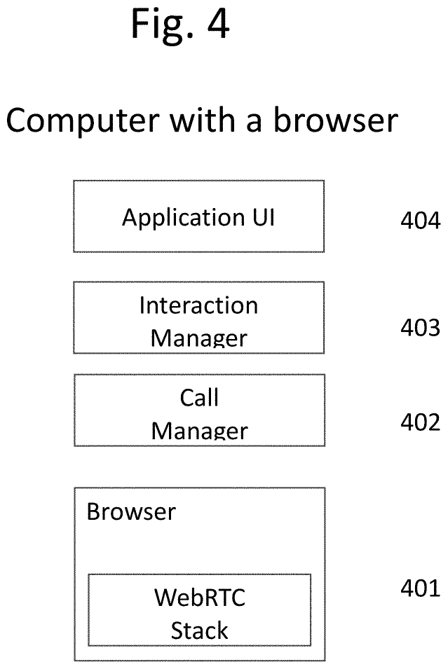

In one embodiment, the computer with a browser stack has the following components (FIG. 4). It has a browser with WebRTC stack or equivalent (401) which allows video streams to be encoded and decoded. It has a Call Manager (402) which coordinates the control messages to and from the connection server. It has an interaction manager (403) that coordinates interaction of one user with the stack with the other user (transmitter or receiver). It has an Application User Interface (UI) (404) that enables the interaction of the user with the video call.

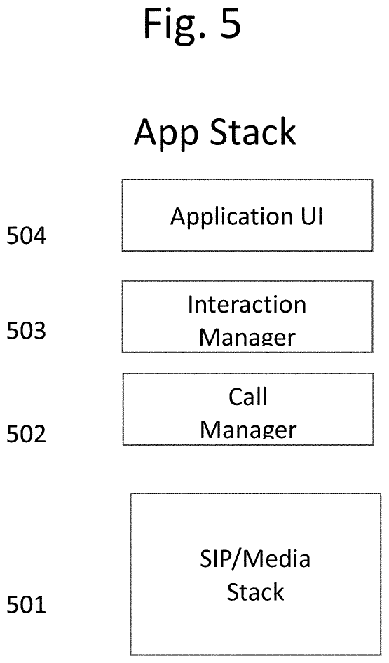

If a user is using an application in a smartphone or computer system (FIG. 5), then the app stack instead of a browser uses a Media Module which can be a SIP module or equivalent. It also has Call Manager (502), Interaction Manager (503), and Application UI (504) which has the same description as their counterparts in FIG. 4.

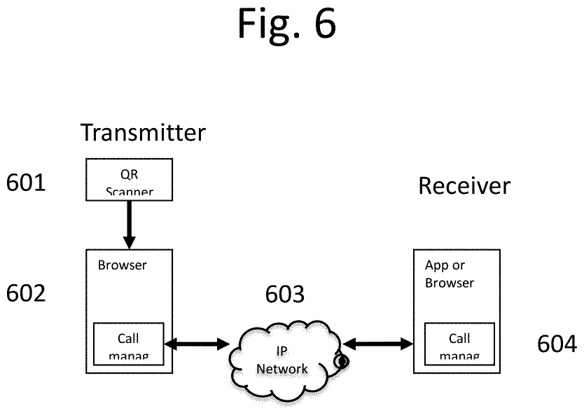

In one embodiment as shown in FIG. 6, the user can see a QR code in a printed material and use the scanner on the user's smart phone (601). The single-action URL code then starts the browser and call manager inside the browser (602) starts the video call. The video call is sent through the IP network (603) to the Receiver (604). If the receiver accepts the call, then the video call is established.

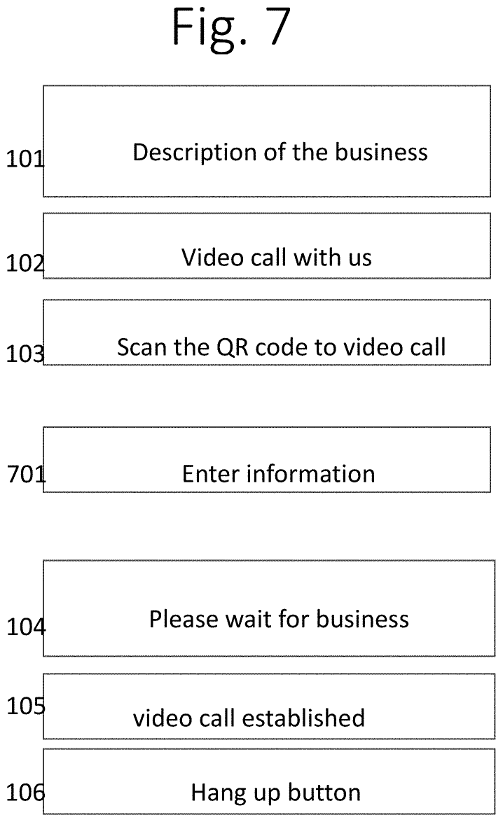

In all above cases the transmitter is not known to the receiver and as such, it is anonymous, since single-action means the video call will be established regardless of prior knowledge of receiver. However, if the receiver requires some information from the transmitter, then it can request a form to be filled up prior to the video call establishment as shown in FIG. 7. After step 102 or 103, the transmitter is presented a form that needs to be filled up (step 701) after which the video call will be established.

Although the algorithm has been described as having step 701 happening before connecting stage of video call, it could be implemented that the video call is established first and then the form is shown to the transmitter. One skilled in the art would recognize that there are other possible combinations of these stages which still express the same essential algorithm.

It is also possible that a single action video call request can be routed to multiple users. For example, a consumer calls the sales line of a business. In this case, the system will route the calls to all users that have indicated they are available to take the single action video call based on a specific criterion. The criterion can be ring all and whomever answered first, will get the call, connect the video call based on round-robin, or based on time of day. It is also possible to connect the single-action call based on language (i.e., if the customer prefers to talk Spanish) or location (i.e., connect the call to the sales person in Los Angeles).

Although the present invention has been described in terms of various embodiments, it is not intended that the invention be limited to these embodiments. Modification within the spirit of the invention will be apparent to those skilled in the art. For example, the connection server may reside in the receiver or the network that the receiver is operating on. Also, even though IP network is specifically mentioned, the same system can operate on ATM network or other non-IP networks.

Although a single-action may be preceded by multiple physical movements of the user (e.g., moving a mouse so that a mouse pointer is over a button), the single-action generally refers to a single event received by a receiver system that indicates the video call intention.

The scope of the present invention is defined by the claims that follow.

We claim:

1. A method of placing a video call from a transmitter to a receiver comprising:
a transmitter that has a microphone and camera,
a receiver that has a microphone and camera,
a control channel,
a server that hosts the information about the intended receiver displaying information identifying the receiver; and
in response to only a single action being performed by the receiver not known to the system, sending a request to establish a video call channel to a server system;
under control of a single-action call placement component of the server system,
receiving the request;
retrieving the network location information previously stored for the receiver identified by the identifier in the transmitter request;
Notifying the receiver of the intended communication
And establishing the video connection based on the receiver acceptance of the video call request.

2. The method of claim 1, wherein the receiver and transmitter can use different control protocols.

3. The method of claim 1, wherein the receiver is using Session Initiation Protocol and the transmitter is using WebRTC protocol to establish the call.

4. The method of claim 1, wherein the control channel establishes the video call and terminates the video call.

5. The method of claim 1, wherein a timer starts when the video call is established and the call is terminated when it reaches certain predetermined time

6. The method of claim 1, wherein the single action video call is established only if it is as a result of clicking on a mouse button on a website.

7. The method of claim 7, wherein a call is allowed only if the number of calls from is below a predetermined threshold for any particular website.

8. The method of claim 7, wherein the mouse button click produces single action video call only during certain time of the day

9. The method of claim 1, wherein single action video call can be initiated by scanning of a QR code

10. The method of claim 1, wherein single action video call can be initiated by clicking on a mouse button when it points to a URL in an email or website.

11. The method of claim 1, wherein single action video call is established by touching the smartphone screen

12. The method of claim 1, wherein single action video call can be initiated using sound

13. The method of claim 1, wherein the receiver may require the transmitter to identify itself before accepting the video call.

14. A method of placing a single action video call from a transmitter to a plurality of receivers comprising:
a transmitter that has a microphone and camera,
a plurality of receivers that have a microphone and camera,
a control channel,
a server that hosts the information about the intended receivers displaying information identifying the receivers; and
in response to only a single action being performed, sending a request to establish a video call channel to a server system;
under control of a single-action call placement component of the server system,
receiving the request;
retrieving the network location information previously stored for the receivers identified by the identifier in the transmitter request;
Based on a pre-set selection criterion notifying a subset of the receivers of the intended communication,
And establishing the video connection based on one of the receivers acceptance of the video call request.

15. The method of claim 15, wherein, the selection criteria is to connect to a receiver in a round robin fashion

16. The method of claim 15, wherein, the selection criteria is to send the video call to all receivers and connect the one that accepts the call first.

17. The method of claim 15, wherein, the selection criteria is to connect the receiver based on time of day, or other information that may be contained in the request, i.e., language.

18. The method of claim 15, wherein, a receiver can decline the call and the system continues the call connection attempt to other receivers.

19. A server system for single action video call comprising:
a data storage medium storing information for a plurality of users; and
a single action video connection component including:
A receiving component for receiving request from a user who is not known to the system for a video call connection; a request including an indication of one of the plurality of users, the request being sent in response to only a single action being performed; and
a video call connection component that retrieves from the data storage medium information for the indicated user and that uses the retrieved information to send a video call indication to the indicated user; and a video call establishment component that establishes the video call in accordance with the request received by the single action video connection component.

20. The method of claim 15, wherein the request received by the single action component has information about the requester that can be passed to the user
